(19) United States
(12) Patent Application Publication
(10) Pub. No.: US 2015/0167765 A1
(43) Pub. Date: Jun. 18, 2015

(54) TRI-CAM BRAKE ASSEMBLY

(71) Applicant: Bendix Commercial Vehicle Systems LLC, Elyria, OH (US)

(72) Inventor: Ronald S. Plantan, Mooresville, NC (US)

(21) Appl. No.: 14/104,833

(22) Filed: Dec. 12, 2013

(51) Int. Cl. F16D 65/22; F16D 51/28

(52) U.S. Cl. CPC F16D 65/22; F16D 51/28

(57) ABSTRACT

A drum brake assembly for a vehicle includes a drum brake housing and a brake assembly. The brake assembly includes an action cam that is actuated by an associated cam shaft when it is desirable to decelerate the vehicle, a first reaction cam matingly engaging the action cam, and a second reaction cam matingly engaging the action cam. The first reaction cam is actuated by the mating engagement based on actuation of the action cam. The second reaction cam is actuated by the mating engagement based on actuation of the action cam.

### BACKGROUND

The present invention relates to a vehicle braking assembly. It finds particular application in conjunction with a cam assembly in a vehicle braking drum and will be described with particular reference thereto. It will be appreciated, however, that the invention is also amenable to other applications.

A vehicle brake drum housing typically includes a plurality of brake shoes. Each brake shoe includes at least one brake pad. When it is desired to decelerate an associated vehicle, an S-Cam is rotated to move the brake shoes and the corresponding brake pads toward an interior surface of the brake drum housing. Vehicle deceleration is achieved when the brake pads frictionally engage the interior surface of the brake drum housing.

S-Cam drum brakes may have adverse torque characteristics and brake noise when a cam shaft associated with the S-Cam is rotated in a direction opposite to a direction of the associated wheel while the vehicle is moving forward. The adverse torque characteristics may result in shorter than desired life of the brake pads. Some truck suspensions require opposite cam shaft installations for proper fit-up.

The present invention provides a new and improved apparatus and method for a vehicle braking assembly.

### SUMMARY

In one aspect of the present invention, it is contemplated that a drum brake assembly for a vehicle includes a drum brake housing and a brake assembly. The brake assembly includes an action cam that is actuated by an associated cam shaft when it is desirable to decelerate the vehicle, a first reaction cam matingly engaging the action cam, and a second reaction cam matingly engaging the action cam. The first reaction cam is actuated by the mating engagement based on actuation of the action cam. The second reaction cam is actuated by the mating engagement based on actuation of the action cam.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a simplified component diagram of an exemplary brake drum assembly in accordance with one embodiment of an apparatus illustrating principles of the present invention;

FIG. 2 illustrates a schematic representation of a side view of the brake drum assembly of FIG. 1 with brake pads that are relatively new in accordance with one embodiment of an apparatus illustrating principles of the present invention;

FIG. 3 illustrates a schematic representation of a side view of the brake drum assembly of FIG. 1 with brake pads that are relatively worn in accordance with one embodiment of an apparatus illustrating principles of the present invention;

FIG. 4 illustrates a partial schematic representation of a brake drum assembly having a cam-same actuation in accordance with one embodiment of an apparatus illustrating principles of the present invention;

FIG. 5 illustrates a partial schematic representation of a brake drum assembly having a cam-opposite actuation in accordance with one embodiment of an apparatus illustrating principles of the present invention; and

FIG. 6 is an exemplary methodology of an operation of a brake drum assembly in accordance with one embodiment illustrating principles of the present invention.

### DETAILED DESCRIPTION OF ILLUSTRATED EMBODIMENT

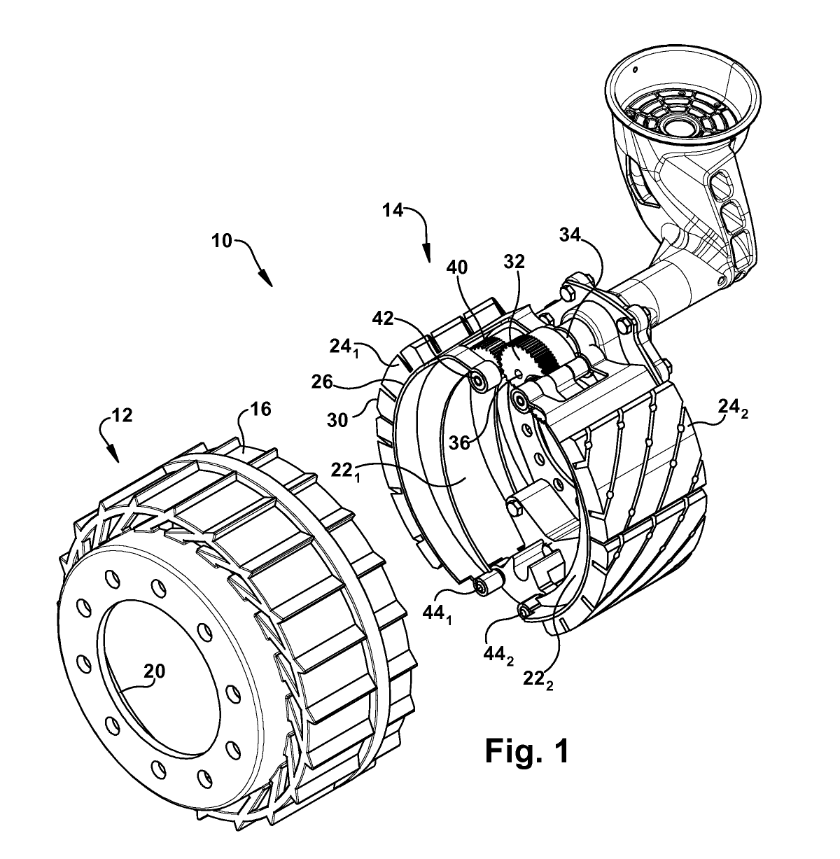

With reference to FIG. 1, a simplified component diagram of an exemplary brake drum assembly 10 is illustrated in accordance with one embodiment of the present invention. The brake drum assembly 10 includes a drum housing 12 and a brake assembly 14. The drum housing 12 is generally circular. The drum housing 12 includes an exterior surface 16 and an interior surface 20.

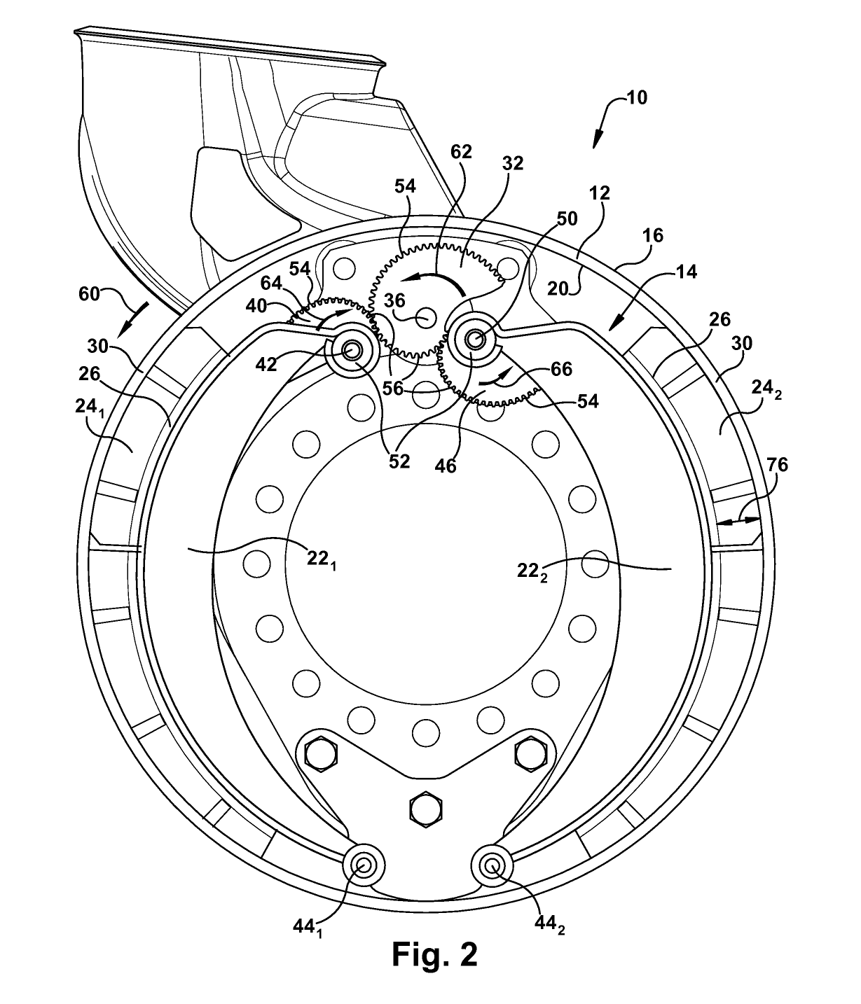

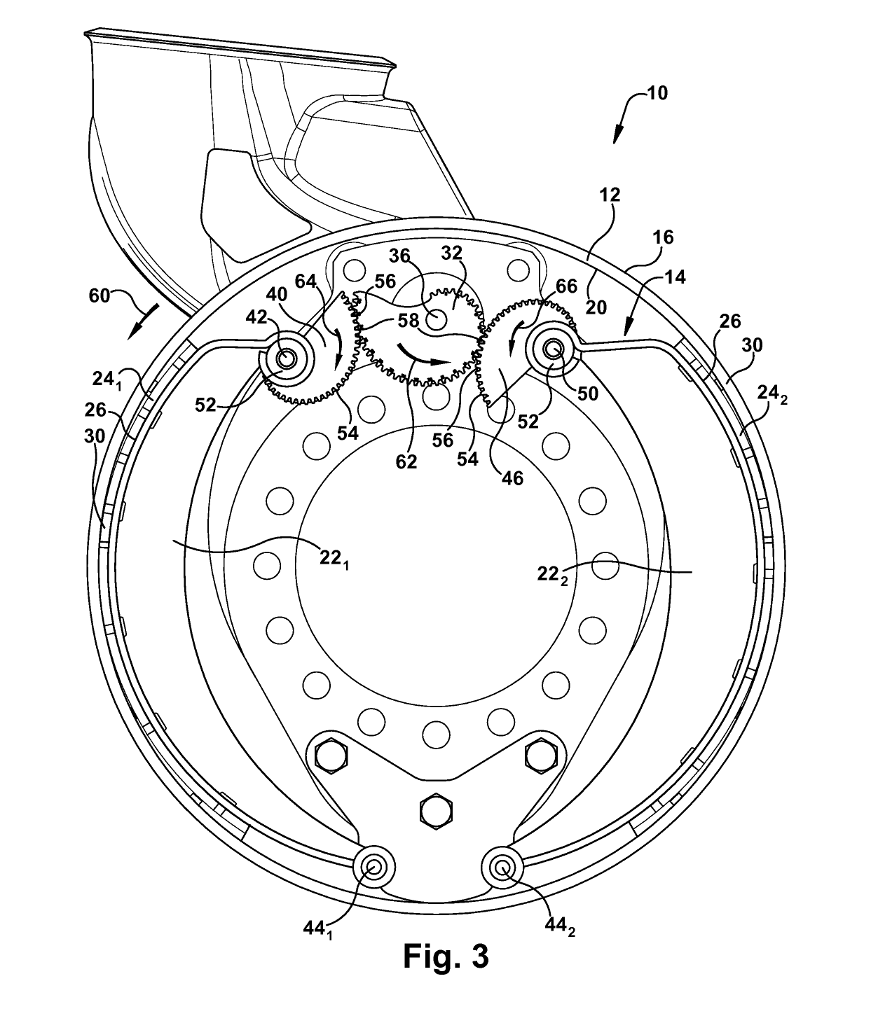

FIGS. 2 and 3 illustrate side views of the brake drum assembly 10. The brake assembly 14 includes at least one brake shoe 22 and a braking material 24 secured to the shoe 22. In one embodiment, the braking material 24 is a brake pad having an inner surface 26 secured to the brake shoe 22. The brake pad 24 is a frictional material having an outer surface 30 that acts as a braking surface and engages the interior surface 20 of the brake drum housing 12 when it is desired to slow an associated vehicle. As discussed in more detail below, the brake assembly 14 is illustrated as including two (2) brake shoes 22_{1,2} (collectively referred to as 22) and respective brake pads 24_{1,2} (collectively referred to as 24) secured to the brake shoes 22_{1,2}. The brake pad 24₁ is secured to the brake shoe 22₁, and the brake pad 24₂ is secured to the brake shoe 22₂.

The brake pads 24 illustrated in FIG. 2 are relatively new, while the brake pads 24 illustrated in FIG. 3 are relatively worn. Therefore, the brake pads 24 shown in FIG. 2 are illustrated as relatively thicker than the brake pads 24 shown in FIG. 3. It is contemplated that brake pads 24_{1,2} having thicknesses of more than 1″, which are relatively thicker than convention pads that may be about ½″ thick, may be used.

With continued reference to FIGS. 2 and 3, the brake assembly 14 includes an action cam 32 secured to an associated cam shaft 34 (see FIG. 1) of the vehicle via an action cam hinge pin 36. A first reaction cam 40 is matingly engaged to the action cam 32. The first reaction cam 40 is secured to the first brake shoe 22₁ via a first reaction cam hinge pin 42. The first brake shoe 22₁ is pivotally mounted to the drum brake housing 12 via a first fastener 44₁. A second reaction cam 46 is matingly engaged to the action cam 32. The second reaction cam 46 is secured to the second brake shoe 22₂ via a second reaction cam hinge pin 50. The second brake shoe 22₂ is pivotally mounted to the drum brake housing 12 via a second fastener 44₂. In one embodiment, respective bearings 52 are around each of the action cam hinge pin 36, the first reaction cam hinge pin 42, and the second reaction cam hinge pin 50.

In the illustrated embodiment, the mating engagement between the action cam 32 and the first reaction cam 40 includes gear teeth 54 and gear landings 56 on both the action cam 32 and the first reaction cam 40. The gear teeth 54 and gear landings 56 on the action cam 32 and the first reaction cam 40 act as engagement surfaces that matingly engage so that the first reaction cam 40 is rotated (e.g., actuated) when the action cam 32 rotates (e.g., actuates). In other words, the first reaction cam 40 is rotated (e.g., actuated) based on, and the mating engagement with, the rotation (e.g., actuation) of the action cam 32. Therefore, the first reaction cam 40 is indirectly rotated (e.g., actuated) when the cam shaft 34 rotates (e.g., actuates) the action cam 32.

The mating engagement between the action cam 32 and the second reaction cam 46 also includes the gear teeth 54 and the gear landings 56 on both the action cam 32 and the second reaction cam 46. The gear teeth 54 and gear landings 56 on the action cam 32 and the second reaction cam 46 act as engagement surfaces that matingly engage so that the second reaction cam 46 is rotated (e.g., actuated) when the action cam 32 rotates (e.g., actuates). In other words, the second reaction cam 46 is rotated (e.g., actuated) based on the rotation (e.g., actuation) of, and the mating engagement with, the action cam 32. Therefore, the second reaction cam 46 is indirectly rotated (e.g., actuated) when the cam shaft 34 rotates (e.g., actuates) the action cam 32.

The respective actuations of the first reaction cam 40 and the second reaction cam 46 are coordinated (synchronized) by the respective mating engagements with the action cam 32. In other words, the coordination of the respective actuations of the first reaction cam 40 and the second reaction cam 46 creates substantially equal (e.g., equivalent) braking forces applied by the first brake pad 24₁ and the second brake pad 24₂ to the drum brake housing 12.

In one embodiment, the means for creating substantially equal (e.g., equivalent) braking forces applied by the first brake pad 24₁ and the second brake pad 24₂ to the drum brake housing 12 includes the action cam 32, the first reaction cam 40, and the second reaction cam 46.

In one embodiment, it is assumed the brake drum housing 12 rotates in a counterclockwise direction as indicated by arrow 60. It is also assumed that the action cam 32 is rotated (e.g., actuated) in a counterclockwise direction as indicated by arrow 62. The counterclockwise rotation (e.g., actuation) 62 of the action cam 32 causes the first reaction cam 40 to be indirectly rotated (e.g., actuated) in the clockwise direction as indicated by arrow 64. The counterclockwise rotation (e.g., actuation) of the action cam 32 also causes the second reaction cam 46 to be indirectly rotated (e.g., actuated) in the counterclockwise direction as indicated by arrow 66. Since the action cam 32 is rotated (e.g., actuated) in the counterclockwise direction 62, the first reaction cam 40 is referred to as the leading reaction cam, and the second reaction cam 46 is referred to as the trailing reaction cam.

Since the action cam 32 is rotated (e.g., actuated) in the same direction as the brake drum housing 12 in the illustrated embodiment (i.e., in the counterclockwise direction as illustrated by the arrows 62, 60). The action cam 32 rotation is referred to as cam-same. Other embodiments, in which the action cam 32 is rotated (e.g., actuated) in a different direction as the brake drum housing 12 (i.e., the action cam 32 is rotated (e.g., actuated) in the counterclockwise direction while the brake drum housing 12 is rotated in the clockwise direction) are also contemplated. In such other embodiments, the action cam 32 rotation is referred to as cam-opposite.

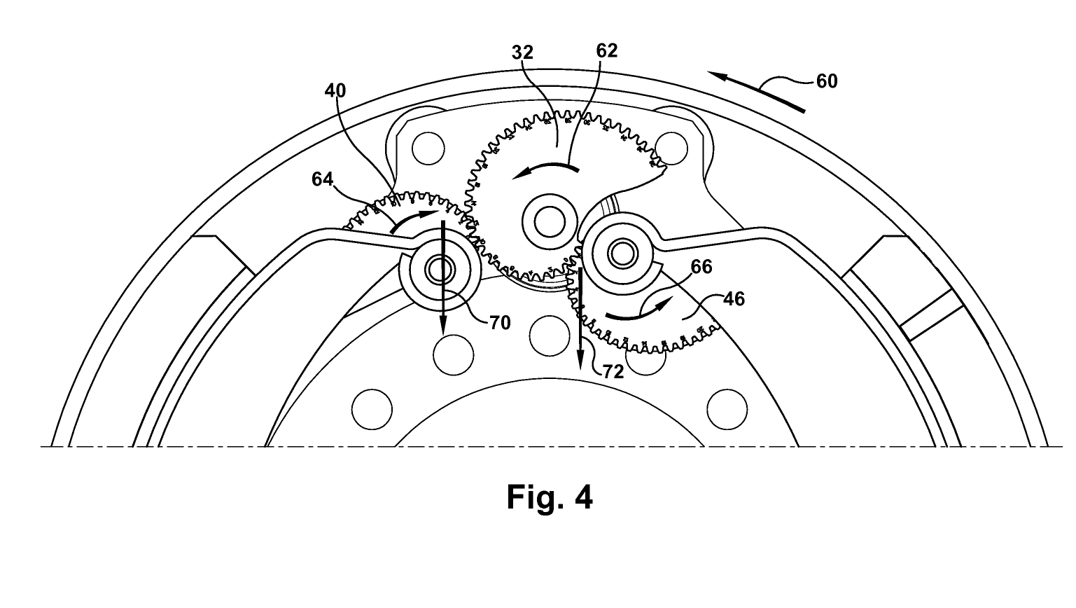

With reference to FIG. 4, the action cam 32 rotation is cam-same. The action cam 32 applies a first downward force vector 70 to the first reaction cam 40. The action cam 32 also applies a second downward force vector 72 to the second reaction cam 46.

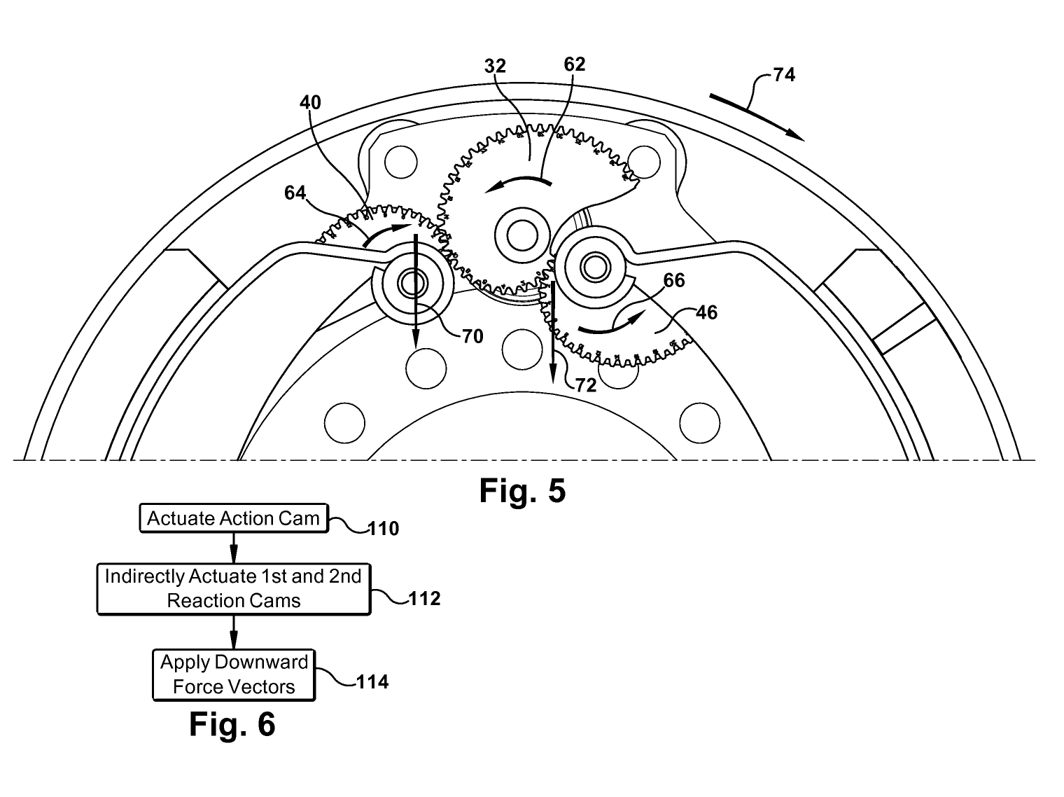

With reference to FIG. 5, the action cam 32 rotation is cam-opposite. More specifically, the brake drum housing 12 rotates in a clockwise direction as indicated by arrow 74. It is also assumed that the action cam 32 is rotated (e.g., actuated) in the counterclockwise direction as indicated by the arrow 62. The counterclockwise rotation (e.g., actuation) 62 of the action cam 32 causes the first reaction cam 40 to be indirectly rotated (e.g., actuated) in the clockwise direction as indicated by the arrow 64. The counterclockwise rotation (e.g., actuation) of the action cam 32 also causes the second reaction cam 46 to be indirectly rotated (e.g., actuated) in the counterclockwise direction as indicated by the arrow 66. The action cam 32 applies the first downward force vector 70 to the first reaction cam 40. The action cam 32 also applies the second downward force vector 72 to the second reaction cam 46. Since the action cam 32 is rotated (e.g., actuated) in the counterclockwise direction 62, the second reaction cam 46 is referred to as the leading reaction cam, and the first reaction cam 40 is referred to as the trailing reaction cam.

With reference to FIGS. 4 and 5, the action cam 32 applies downward force vectors to the first reaction cam 40 (see 70) and the second reaction cam 46 (see 72) when the action cam 32 rotation is cam-same (FIG. 4) and when the action cam 32 rotation is cam-opposite (FIG. 5). Applying downward force vectors to the first reaction cam 40 and the second reaction cam 46 results in substantially equal braking forces applied to the first and second brake pads 24_{1,2} regardless of whether the action cam 32 rotation is cam-same or cam-opposite. Applying substantially equal braking forces to the first and second brake pads 24_{1,2} results in better braking performance and improved brake pad life. With reference to FIG. 2, it is contemplated that brake pads 24_{1,2} that are more than 1″ in thickness can be used. For example, a thickness 76 illustrated in FIG. 2 is, for example, about 1.04″. The three (3) separately hinged cams (i.e., the action cam 32 rotating around the action cam hinge pin 36, the first reaction cam 40 rotating around the first reaction cam hinge pin 42, and the second reaction cam 46 rotating around the second reaction cam hinge pin 50) improve the force application at both of the brake shoes 22_{1,2} and, furthermore, increase the available space within the drum housing 12 for the relatively thicker brake pads 24_{1,2} (e.g., to accommodate the about 1.04″ pads 24_{1,2} illustrated, or even thicker).

FIG. 6 illustrates an exemplary methodology of the system shown in FIGS. 1-5. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 2, 3, and 6, when it is desired to decelerate (e.g., brake) the associated vehicle, the action cam 32 is actuated in a step 110 by rotating the cam shaft 34. Rotating the cam shaft 34 in the step 110 causes the action cam 32 to rotate around the action cam hinge pin 36. As discussed above, in a step 112 the first and second reaction cams 40, 46, respectively, are indirectly actuated in a coordinated (synchronized) manner by the actuation of the action cam 32 and the cam shaft 34. The actuation of the first reaction cam 40 causes the first reaction cam 40 to rotate around the first reaction cam hinge pin 42. The actuation of the second reaction cam 46 causes the second reaction cam 46 to rotate around the second reaction cam hinge pin 50.

In one embodiment, it is assumed the brake drum housing 12 rotates in a counterclockwise direction as indicated by arrow 60. It is also assumed that the action cam 32 is rotated (e.g., actuated) in a counterclockwise direction as indicated by arrow 62 in the step 110. The counterclockwise rotation (e.g., actuation) of the action cam 32 causes the first reaction cam 40 to be indirectly rotated (e.g., actuated) in the clockwise direction as indicated by arrow 64 in the step 112. The counterclockwise rotation (e.g., actuation) of the action cam 32 also causes the second reaction cam 46 to be indirectly rotated (e.g., actuated) in the counterclockwise direction as indicated by arrow 66 in the step 112.

As discussed above, the coordinated (synchronized) actuation of the first and second reaction cams 40, 46, respectively, causes the first brake shoe 22₁ to apply the first brake pad 24₁ to the drum housing 12 and the second brake shoe 22₂ to apply the second brake pad 24₂ to the drum housing 12 to create substantially equal braking forces of the first and second brake pads 24_{1,2} against the drum housing 12.

In addition, as also discussed above, the step 112 of indirectly actuating the first reaction cam 40 includes matingly engaging the action cam 32 and the first reaction cam 40 with the gear teeth 54 and gear landings 56. Similarly, the step 112 of indirectly actuating the second reaction cam 46 includes matingly engaging the action cam 32 and the second reaction cam 46 with the gear teeth 54 and gear landings 56.

In a step 114, since the action cam 32 rotation is cam-same, the first downward force vector 70 is applied by the action cam 32 to the first reaction cam 40 while the first reaction cam 40 is indirectly actuated in the step 112. In addition, in the step 114, the second downward force vector 72 is applied by the action cam 32 to the second reaction cam 46 while the second reaction cam 46 is indirectly actuated in the step 112.

In the step 114, if the action cam 32 rotation was cam-opposite, the first downward force vector 70 would be applied by the action cam 32 to the first reaction cam 40 while the first reaction cam 40 was indirectly actuated in the step 112. In addition, the second downward force vector 72 would be applied by the action cam 32 to the second reaction cam 46 while the second reaction cam 46 was indirectly actuated in the step 112.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/we claim:

1. A drum brake assembly for a vehicle, comprising:
a brake assembly, comprising:
an action cam that is actuated by an associated cam shaft when it is desirable to decelerate the vehicle;
a first reaction cam matingly engaging the action cam, the first reaction cam being actuated by the mating engagement based on actuation of the action cam; and
a second reaction cam matingly engaging the action cam, the second reaction cam being actuated by the mating engagement based on actuation of the action cam.

2. The drum brake assembly for a vehicle as set forth in claim 1, wherein:
the respective actuations of the first reaction cam and the second reaction cam are coordinated by the respective mating engagements with the action cam.

3. The drum brake assembly for a vehicle as set forth in claim 2, further including:
a first brake shoe;
a second brake shoe;
a first brake pad secured to the first brake shoe; and
a second brake pad secured to the second brake shoe;
the coordination of the respective actuations of the first reaction cam and the second reaction cam creates substantially equal braking forces applied by the first and second brake pads to an associated drum brake housing.

4. The drum brake assembly for a vehicle as set forth in claim 3, wherein:
the substantially equal braking forces applied to the first and second brake pads increases a life of the first and second brake pads.

5. The drum brake assembly for a vehicle as set forth in claim 3, wherein:
respective thicknesses of at least about 1″ for the first and second brake pads can be accommodated between the first and second brake shoes, respectively, and the associated drum brake housing.

6. The drum brake assembly for a vehicle as set forth in claim 3, wherein:
respective force vectors are applied in corresponding respective directions to the first reaction cam and the second reaction cam when the action cam is actuated.

7. The drum brake assembly for a vehicle as set forth in claim 6, wherein:
the respective force vectors are applied in the corresponding respective directions to the first reaction cam and the second reaction cam in both a cam same direction and a cam opposite direction.

8. The drum brake assembly for a vehicle as set forth in claim 7, wherein:
the respective force vectors are applied in corresponding respective downward directions to the first reaction cam and the second reaction cam when the action cam is actuated.

9. The drum brake assembly for a vehicle as set forth in claim 1, further including:
respective hinge pins around which each of the action cam the first reaction cam, and the second reaction cam rotates; and
bearings around the respective hinge pins.

10. The drum brake assembly for a vehicle as set forth in claim 1, wherein:
the action cam rotates in a first direction when actuated by the associated cam shaft to decelerate the vehicle;
the first reaction cam rotates in a second direction when actuated by the mating engagement of the actuated action cam;
the second reaction cam rotates in the first direction when actuated by the mating engagement of the actuated action cam.

11. A brake assembly for a vehicle, the brake assembly comprising:
an action cam that is rotated by an associated cam shaft when it is desirable to decelerate the vehicle;
a first reaction cam matingly engaging the action cam, the first reaction cam being rotated by the mating engagement based on the rotation of the action cam; and
a second reaction cam matingly engaging the action cam, the second reaction cam being rotated by the mating engagement based on the rotation of the action cam.

12. The brake assembly for a vehicle as set forth in claim 11, wherein:
the respective rotations of the first reaction cam and the second reaction cam are synchronized by the respective mating engagements with the action cam.

13. The brake assembly for a vehicle as set forth in claim 12, further including:
a first brake shoe;
a second brake shoe;
a first brake pad secured to the first brake shoe; and
a second brake pad secured to the second brake shoe;
the synchronization of the respective rotations of the first reaction cam and the second reaction cam apply substantially equivalent braking forces to the first and second brake pads.

14. The brake assembly for a vehicle as set forth in claim 13, wherein:
respective force vectors are applied in corresponding respective directions to the first reaction cam and the second reaction cam when the action cam is actuated.

15. The brake assembly for a vehicle as set forth in claim 14, wherein:
the respective force vectors are applied in the corresponding respective downward directions to the first reaction cam and the second reaction cam in both a cam same direction and a cam opposite direction.

16. A drum brake assembly for a vehicle, comprising:
a drum brake housing; and
a brake assembly, comprising:
a first brake pad;
a second brake pad; and
means for creating substantially equal braking forces applied by the first and second brake pads to the drum brake housing.

17. The drum brake assembly for a vehicle as set forth in claim 16, wherein the means for creating substantially equal braking forces includes:
an action cam that is actuated by an associated cam shaft when it is desirable to decelerate the vehicle;
a first reaction cam matingly engaging the action cam;
a second reaction cam matingly engaging the action cam.

18. The drum brake assembly for a vehicle as set forth in claim 17, further including:
a first brake shoe, the first brake pad being secured to the first brake shoe; and
a second brake shoe, the second brake pad being secured to the second brake shoe.

19. The drum brake assembly for a vehicle as set forth in claim 17, wherein:
the means for creating substantially equal braking forces coordinates respective actuations of the first reaction cam and the second reaction cam based on the actuation of the action cam.

20. The drum brake assembly for a vehicle as set forth in claim 17, wherein:
the means for creating substantially equal braking forces results in respective force vectors applied in corresponding respective downward directions to the first reaction cam and the second reaction cam when the action cam is actuated.

21. A drum brake assembly for a vehicle, comprising:
a drum brake housing; and
a brake assembly, comprising:
an action cam that is actuated by an associated cam shaft when it is desirable to decelerate the vehicle;
an action cam engagement surface;
a leading reaction cam including a leading reaction cam engagement surface matingly engaging the action cam engagement surface, the leading reaction cam being actuated by the mating engagement based on actuation of the action cam; and
a trailing reaction cam including a trailing reaction cam engagement surface matingly engaging the action cam engagement surface, the trailing reaction cam being actuated by the mating engagement based on actuation of the action cam, the respective actuations of the leading reaction cam and the trailing reaction cam being coordinated by the respective mating engagements of the leading reaction cam engagement surface and the trailing reaction cam engagement surface with the action cam engagement surface.

22. The drum brake assembly for a vehicle as set forth in claim 21, wherein:
the respective actuations of the first reaction cam and the second reaction cam are coordinated by the respective mating engagements of the leading reaction cam engagement surface and the trailing reaction cam engagement surface with the action cam engagement surface.

23. The drum brake assembly for a vehicle as set forth in claim 21, wherein:
each of the action cam engagement surface, the leading reaction cam engagement surface, and the trailing reaction cam engagement surface includes respective gear teeth and landings;
the gear teeth and landings of the action cam matingly engage the gear teeth and landings of the leading reaction cam; and
the gear teeth and landings of the action cam matingly engage the gear teeth and landings of the trailing reaction cam.

24. The drum brake assembly for a vehicle as set forth in claim 21, further including:
a first brake shoe;
a second brake shoe;
a first brake pad secured to the first brake shoe; and
a second brake pad secured to the second brake shoe;
wherein respective force vectors are applied in corresponding respective downward directions to the first reaction cam and the second reaction cam when the action cam is actuated.

25. The drum brake assembly for a vehicle as set forth in claim 24, wherein:
the coordination of the respective actuations of the first reaction cam and the second reaction cam creates substantially equal braking forces applied by the first and second brake pads to the drum brake housing.

26. A method for applying brake pads to a drum brake housing in a drum brake assembly for a vehicle, the method comprising:
actuating an action cam when it is desirable to decelerate the vehicle;
indirectly actuating a first reaction cam engaged to the action cam;
indirectly actuating a second reaction cam engaged to the action cam; and
causing a first brake shoe associated with the first reaction cam to apply first brake pads against the drum brake housing while causing, in a coordinated manner with applying the first brake pad against the drum brake housing, a second brake shoe associated with the second reaction cam to apply second brake pads against the drum brake housing.

27. The method for applying brake pads to a drum brake housing as set forth in claim 26, wherein the step of causing the first brake shoe associated with the first reaction cam to apply the first brake pads against the drum brake housing while causing, in a coordinated manner with applying the first brake pad against the drum brake housing, the second brake shoe associated with the second reaction cam to apply the second brake pads against the drum brake housing includes:
indirectly actuating the first and second reaction cams to create substantially equal braking forces applied by the first and second brake pads to the drum brake housing.

28. The method for applying brake pads to a drum brake housing as set forth in claim 26, wherein the step of actuating the action cam includes:
rotating the action cam via an associated cam shaft.

29. The method for applying brake pads to a drum brake housing as set forth in claim 26, wherein:
the step of indirectly actuating the first reaction cam includes:
matingly engaging the action cam and the first reaction cam with gear teeth and landings; and
the step of indirectly actuating the second reaction cam includes:
matingly engaging the action cam and the second reaction cam with gear teeth and landings.

30. The method for applying brake pads to a drum brake housing as set forth in claim 26, further including:
while indirectly actuating the first reaction cam, applying a downward force vector to the first reaction cam; and
while indirectly actuating the second reaction cam, applying a downward force vector to the second reaction cam.
